(19) United States
(12) Patent Application Publication
(10) Pub. No.: US 2014/0108110 A1
(43) Pub. Date: Apr. 17, 2014

(54) Goal-Oriented Long Term Incentive Learning, Feedback and Survey Award System

(71) Applicants: Jie Tan, Tarrytown, NY (US); Harry Truong MOKM, Seattle, WA (US)

(72) Inventors: Jie Tan, Tarrytown, NY (US); Harry Truong MOKM, Seattle, WA (US)

(21) Appl. No.: 13/784,943

(22) Filed: Mar. 5, 2013

Related U.S. Application Data
(63) Continuation-in-part of application No. 13/650,923, filed on Oct. 12, 2012.
(60) Provisional application No. 61/745,747, filed on Dec. 24, 2012.

(51) Int. Cl. G06Q 30/02

(52) U.S. Cl. CPC G06Q 30/0208
USPC 705/14.11; 705/14.17

(57) ABSTRACT

A long term goal oriented incentive learning and feedback award system is disclosed. A plurality of third party providers are enabled to directly provide financial incentives to a user in exchange for a specific user performance. A user is enabled to set up a trust account on the system to accumulate the financial incentives under the restriction of a long term goal. The long term goal includes supporting college education, supporting retirement, staring a business, or patenting an innovation. A user performance includes a school study, a feedback to teachers or a feedback about a medicine or a political survey.

### CROSS-REFERENCE

This is application is a continuation-in-part to the U.S. application Ser. No. 13/650,923, filed on Oct. 12, 2012, from which priority is claimed, and entirety of which is hereby incorporated by reference. This Application also claims the priority of the U.S. Provisional Application No. 61/745,747, filed on Dec. 24, 2012, the entirety of which is hereby incorporated by reference.

### DESCRIPTION OF RELATED ART

The present application relates to an internet on-line and/or wireless mobile network system for providing long term goal oriented incentive programs for learning, feedback and surveys. More particularly, an electronic internet system and a mobile device are enabled to provide access to incentive providing learning, feedback and survey programs to award real financial incentives, and to enable a user to combine and accumulate financial incentives for long term goals.

Note that the points discussed below may reflect the hindsight gained from the disclosed inventions, and are not necessarily admitted to be prior art.

Most of the current learning systems are focused on providing contents. Great energy and talents have been concentrated on developing the most interesting or interactive contents to attract students to learn, such as audios, videos and games, etc. However, in the practical world, students may lack the initial incentives or motivations to start to use these content oriented programs.

The current on-line learning or feedback systems generally either do not provide initial incentives, or simply provide short term incentives on time sensitive basis, or a lottery like promotions that require luck. These incentives are inherently associated with stress, requiring users to participate in a tight time-frame. Such stress based systems, in this already stressful practical world, may present a formidable barrier to a user to participate. Many users may want to avoid using the programs to simply avoid the stress.

Additionally, as the learning materials get more and more multimedia and interactive, learners' patience and attention span are also getting shorter and shorter. Learners become more and more often accustomed to the easy tasks of watching and listening while choose to stay idle. Other learners may be easily distracted by the multimedia itself which obscures the real learning material. A frustrated user may be then not motivated to stick to the course of learning.

The question is how to get a user to be initiated to perform the task and stick to the course?

As Mr. Bill Gates states in his year 2013 World Economic Forum speech that “an innovation—whether it's a new vaccine or an improved seed, or a new class material—can't have an impact unless it reaches the people who will benefit from it. We need innovations in measurement to find new, effective ways to deliver those tools and services to the clinics, family farms and classrooms that need them.”

Although this may seem basic, despite innovation in measuring teacher performance world-wide, more than 90% of educators in the U.S. still get zero feedback on how to improve. But “you can achieve incredible progress if you set a clear goal and find a measure that will drive progress toward that goal—in a feedback loop similar to the one Mr. Rosen describes”—Bill Gates declares.

Thus there is a need for an easy to manage tool system that can provide a mutually beneficial, long term, goal-oriented real world incentive for a student to learn, for a user to respond to surveys, for a customer to provide feedbacks for product improvements.

### SUMMARY

The present application discloses a Goal-Oriented Incentive Learning and Feedback Award system (GOILAS) that implements a long term goal incentive-base approach, with mutual benefits both to learners or users and to program providers.

Often due to lack of clear long term goals, learners are not motivated to initiate a learning program, and often lose motivations to stick to a program with even less motivation to feedback to teachers. Other program users may lose motivation entirely before finishing any performing.

However, if the promise of a candy could change Steve Jobs from a troubled student to an advanced learner, an electronic system that provides systematic real world incentives and long term goals should work similar magic to other students.

A system that sets a clear, long term, transferrable financial benefit and goal for a user to perform would initiate a student to learn, and would provide much needed positive feedback loop for the user to persevere in the system in time. The system would allow a user to financially benefit from its learning and use of time for performing the required tasks, encouraging business and innovation as part of the financial incentive to the society as a whole. A conditional award system would also encourage a positive feedback loop among the young generation to establish a positive work ethics and attitude. It envisions a true equal opportunity system where anyone can find a program to participate and be awarded in participation and excel. The learning process itself becomes an awarding process that can be used in the real world.

On the other hand, the system provides a tool for educators, and private charities to directly link financial spending with user's performance, and to be able to directly measure the efficiency of their programs.

In one embodiment, a long term conditional financial incentive is provided to a user. A program provider is required to set up an escrow account with the system to instantly award financial incentives for a user's performance. A conditional, long term goal based piggy bank account is provided to a registered user to accumulate any incentives from using any incentive providing programs. The piggy bank account is allowed to accumulate and grow on any and all of such incentive providing programs. The long term goals include paying college educations or retirement, financing a vacation, providing seed money for starting a business, and paying for patenting innovative ideas, etc.

In one embodiment, a registered user is enabled to search incentive providing programs offered on the system, by key words, by personal information, and by incentive amount or by the most recent offers; is enabled to enter such programs with a single click.

In one embodiment, a program provider is enabled to change and update its programs according to feedback and needs, and also according the progress of a user.

In one embodiment, financial incentives are provided for both participation and for correctness in answering the exercising questions.

In one embodiment, the source of financial incentives may be provided by government grants, charity donations, individual or corporate sponsors, or by parents or a caretaker of the user, or from school tuitions of a student user.

In one embodiment, a search engine application for this system is automatically installed to a user's smart phone, and a user can enter into a provider's program through clicking on the application installed on the cell phone.

In one embodiment, a financial incentive is automatically transferred to a user's piggy bank account upon a submission of a survey or an answer sheet by the user. And a piggy bank account statement is accessible to a user through cell phone or any internet access.

In one embodiment, a provider is enabled to post incentive programs to users directly on the system.

The disclosed innovation, in various embodiments, provides one or more of at least the listed advantages. However, not all of these advantages result from every one of the innovations disclosed, and this list of advantages does not limit the various claimed inventions.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows an example set of functional components for a Goal-oriented Incentive Learning and Feedback Award System (GOILAS) in accordance with this application.

FIG. 2 schematically shows an example set of transactions in a Goal-oriented Incentive Learning and Feedback Award System in accordance with this application.

FIG. 3 schematically shows an example Registration for a program provider in a Goal-oriented Incentive Learning and Feedback Award System in accordance with this application.

FIG. 4 schematically shows an example transactional process at a program provider side in a Goal-oriented Incentive Learning and Feedback Award System in accordance with this application.

FIG. 5 schematically shows an example transactional process at a user side in a Goal-oriented Incentive Learning and Feedback Award System in accordance with this application.

FIG. 6 schematically shows an example user interface at a user side in a Goal-oriented Incentive Learning and Feedback Award System in accordance with this application.

FIG. 7 schematically shows an example architecture of an transaction engine in a Goal-oriented Incentive Learning and Feedback Award System in accordance with this application.

FIGS. 8A and 8B schematically show an example mobile user interface in a Goal-oriented Incentive Learning and Feedback Award System in accordance with this application.

FIG. 9 schematically shows an example Conditional Award Program in a Goal-oriented Incentive Learning and Feedback Award System in accordance with this application.

FIG. 10 schematically shows an example User Piggy Bank Trust Account for a long term purpose in accordance with this application.

FIG. 11 schematically shows an example interaction between a user, a program provider and the GOILAS system in accordance with this application.

FIG. 12A shows an example web interface for an incentive providing feedback program in accordance with this application.

FIG. 12B shows an example web interface for an incentive providing Literature Study program in accordance with this application.

FIG. 12C shows an example web interface for a Piggy Bank Account Statement in accordance with this application.

FIG. 12D shows an example Provider's Account Page in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present invention may be described herein in terms of functional block components and various processing steps in an electronic network and devices. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, Java, COBOL, assembler, PERL, or the like, with the various algorithms being implemented with any combination of data structures, objects, processes, routines, or other programming elements. Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

A “Component” term represents physical replacement part of the system that conforms to and provides an actual realization through a set of interfaces. It includes automated software virtualization interfaces that comprise all the source files, binary code, executables, scripts that are packaged for performing the intended functions.

A “Subsystem” term represents a combination of a package and a class. The package contains all the elements, including unique id elements, models, source files, html files, etc. that has one class that realizes these interfaces to the one unique package. For instance, in IT design terms; a subsystem is an interface user class represented as an actor symbol that can “extend” or “include” the live streaming media and data communication hub package.

An “Engine” term in this application means a computer functional modular having a set of instructions programmed to complete a specific task, solve a problem, by instructing a computer processor.

A “Method(s)” term means a method for object oriented programming code whereas it performs a subroutine and is exclusively associated with a class or an object. Normally, consists of a sequence of programming statements to perform an action, a set of parameters to customize those actions, and possibly an output value (sometimes called a return value).

A “Web-Service” term means an application layer service that executes via a public internet interface and doesn't necessarily imply to be a web site. A web service is one that can be located, discovered, and published via a network channel. Additionally, a web service can also act as an intermediary business application service agent that is an encapsulated service provider, but can also be a service requestor.

For “Network Services”, there are two types. One type of “Network Services” mean file sharing services, file services, collaboration services, and messaging. They can also be located, discovered, and published. Another type of Network Service, taking the form of a Network Interface, implements a standard connection protocol, such as Ethernet, Wireless, etc. “Service” may mean either a Network Service and/or Web Service.

A “Third-Party Provider” term means a program provider other than the GOILAS system and its administering entity. The Third Party Providers include individuals, corporations, government, charities, schools and any other organizations or persons that are not an entity associated with the administering entity of the system of the invention. And the term “Provider” is inter exchangeable with “Third-Party Provider”.

A “User Performance” is a task oriented performance that is not an activity of purchasing. A user is required to perform an activity that is not a purchasing of an item.

A “Trust Account” is an account that is created by a trust agreement, with trustees and beneficiaries.

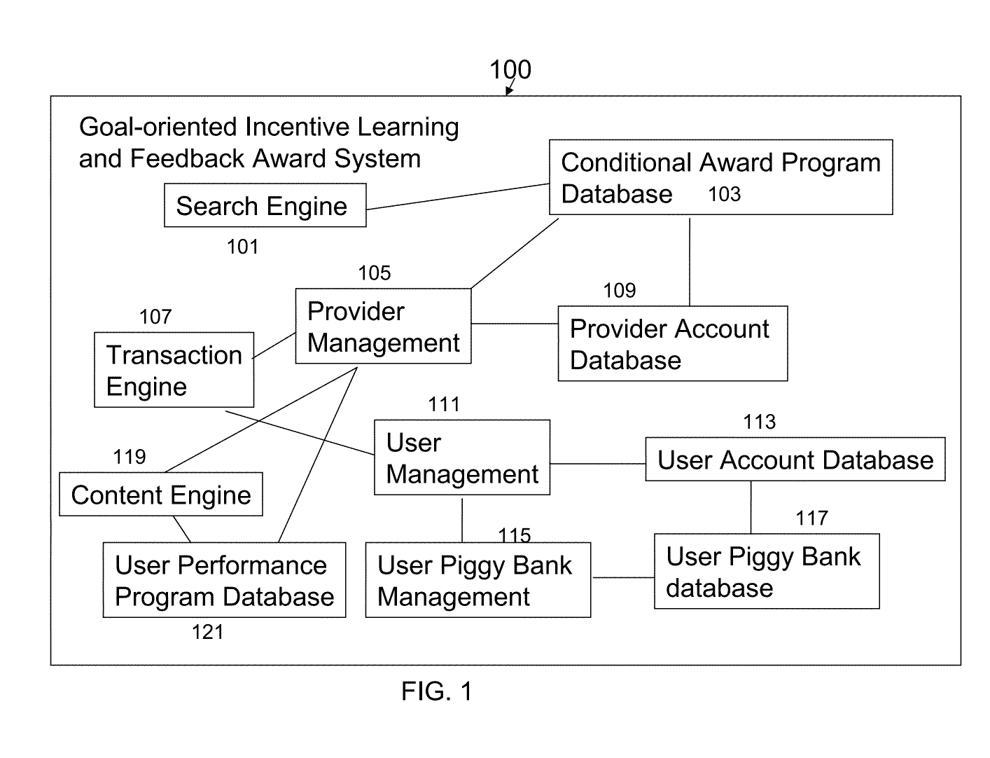

In reference to FIG. 1, a Goal-oriented Incentive Learning and Feedback Award System (GOILAS) 100 includes a Search Engine component 101, a Database 103 for Conditional Award programs offered by various program providers, a Transaction Engine component 107 that includes a Provider Management component 105 and a User Management component 111. Provider Management component 105 provides management functions over a Provider Account Database 109 and the Conditional Award Program database 103. User Management component 111 provides management functions to User Account Database 113 and User Piggy Bank Account 115 that in turn interacts with User Piggy Bank database 117. User Piggy Bank Account is a real bank account for real money, may be setup and managed by a bank or financial entity with such license or permits under any law and regulations. A Piggy Bank Account is a goal oriented Trust Account, payable for the purpose of achieving the pre-set goals. Such goads may include paying college educations or retirement, financing a vacation, providing seed money for starting a business, and paying for patenting innovative ideas. Non-goal use of the account will encounter a penalty severe enough to discourage such use (for example, a 10% fee). But GOILAS can act as co-trustee for the Piggy Bank Accounts.

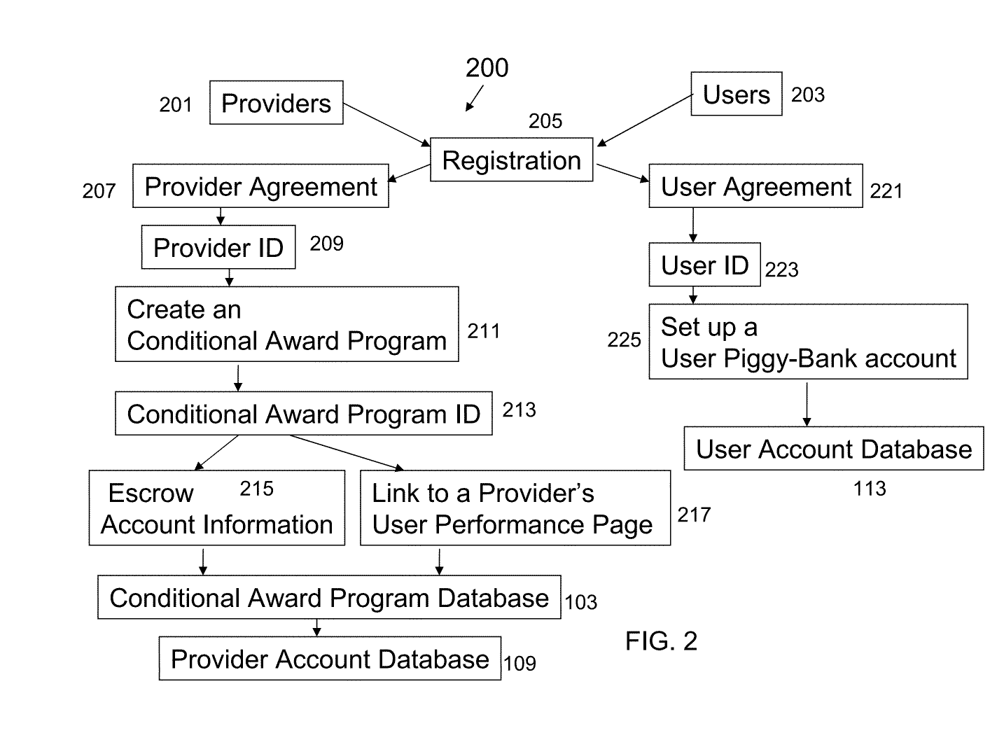

In reference to FIG. 2, an example registration process 200 is shown, by which various functioning components of the GOILAS system are created and saved into the databases. For Program Providers 201, at the system providers' web page, provider 201 goes through a Registration process 205 that inquires a number of information about the provider's identity, and creates a Provider Agreement 207 and Provider ID 209. Provider Agreement 207 may require a provider to promise or commit to set up an escrow account for financing the incentives it promises to provide through the program. The agreement allows the GOILAS system to act as a trustee to the Provider's escrow account to have the right to transfer the promised awards or incentives directly from a provider's escrow account to a user's Piggy Bank.

After receiving a Provider ID, the provider is prompted to create a Conditional Award Program at step 211 in the system that specifies the terms for receiving an award, for example, 10 cents for submitting a survey, 2 cents a correct answer to a question, or a bonus 5 dollar for finishing a full set of exercises; 1 dollar for submitting a feedback for a product, etc. The award can only be awarded after a user's successfully performing specific tasks specified in the Conditional Award Program. In other wards, a user must earn the conditional award by performing a required task.

With a Conditional Award ID and a Provider ID, the system then prompts the provider to set up an escrow account or account information at step 215 to authorize the direct access by the GOILAS system, and link together the Award ID with the escrow account information. The system also prompts the provider to link its Provider's User Performance Page to the Conditional Award ID and system at step 217, allowing a user to enter the Provider's User Performance Page with a simple click in the system. All the information is then saved into the Provider Conditional Award Database 103, and also the Provider Account Database 109 to track and record all the incentive based programs offered by a Provider.

A Provider's User Performance Page may not be implemented directly by the GOILAS system, may be implemented on the provider's own internet service site using other content creating programs. While this arrangement would provide the maximum control to the provider to manage the content and the data that it wishes to collect that it is most suited to analyze, alternatively for the providers who do not operate their own internet site, they may directly implement a User Performance Page on the GOILAS system using a Content Creating Engine 119 provided by the system.

For a User 203, it also goes through the general registration process of 205 by providing the identity information. A User Agreement 221 and a User ID 223 are then generated to authorize the system to be a trustee/co-trustee to set up a Piggy Bank Account for the user with a bank at step 225. The user is prompted to select a long term goal or aim for the Piggy Bank Account, among the example choices are: paying college educations or retirement, financing a vacation, providing seed money for starting a business, and paying for patenting innovative ideas. However, once a goal is set for a given Piggy Bank Account, the goal may not be changed without a penalty. The goal may be changed at a later time by paying a surcharge fee, such as 10-20% of the account amount. The user information and the associated Piggy Bank information are then saved into a User Account Database for management by the system.

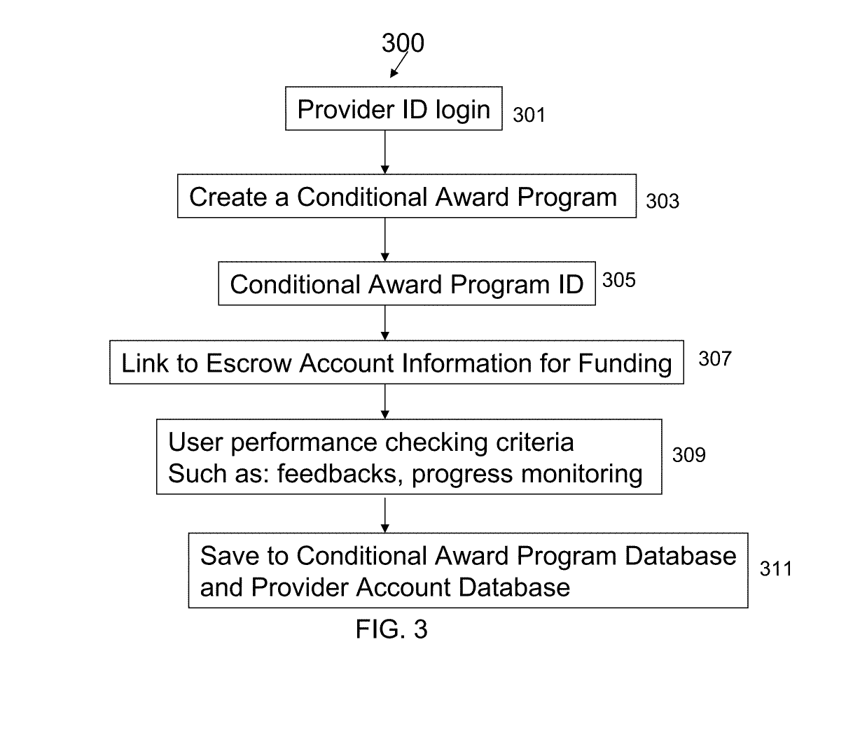

In reference to FIG. 3, for a registered Provider, process 300 is used to register a new Conditional Award Program under this provider. A provider is prompted to use its Provider ID to login to the system at step 301 to its home page in the system. At step 303, a Provider can create a new Conditional Award Program by clicking on a New Program button on its home page. The program specifies the hierarchy of awards and the conditions for such awards. A Conditional Award Program ID is then provided at step 305, and associated Escrow Account Information is provided and linked with the Program ID and accessing authorization is granted to the system at step 307. The provider can also specify a number of filtering criteria for filtering the accesses to the Escrow Account by demanding upon certain satisfactions from a user's performance at step 309. And the information are saved to both Conditional Award Database and Provider Account Database at step 311.

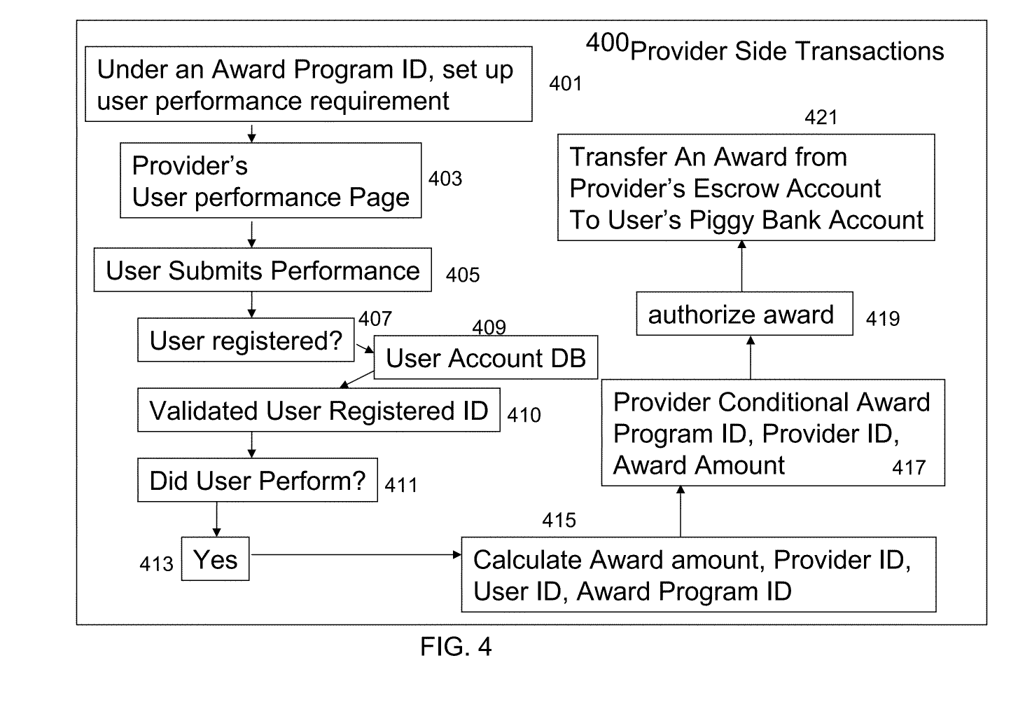

In reference to FIG. 4, a functional flow chart about the transactions 400 associated with a Provider side. At step 401, a provider that has set up a Conditional Award program with the GOILAS system may either set up a user performance requirement on its own service site or on the GOILAS system under the Conditional Award Program ID. At step 403, this requirement is then linked to the Provider's User Performance Page on the Provider's service site, or created on GOILAS system for the Providers who do not operate an internet site themselves. The User Performance Page details about the content and data that the Provider is requiring a User to perform.

Once a User performs and submits its performance from the User Performance Page at step 405, the User Performance Page at the Provider site inquires the GOILAS about the User's registration status at step 407 by prompting the User for User ID, and verifies from its User Account Database. If a User ID is not validated, the performance is temporally saved and the User is prompted to go to GOILAS system to register for a User ID and to create a Piggy Bank Account. Once the User ID is validated at step 410, either the GOILAS system, or alternatively, the Provider's User Performance Page checks whether the user performed as required at step 411, and if it is yes, the performance result is used to calculate the award at step 415 using the Award Program ID and the program. Then the Program ID, Provider ID, and User ID are used to access the User Piggy Bank management engine at step 419, the linked Escrow Account and the user Piggy Bank Account, and to authorize the transfer of the calculated award amount from the linked Escrow Account to the User Piggy Bank Account at step 421.

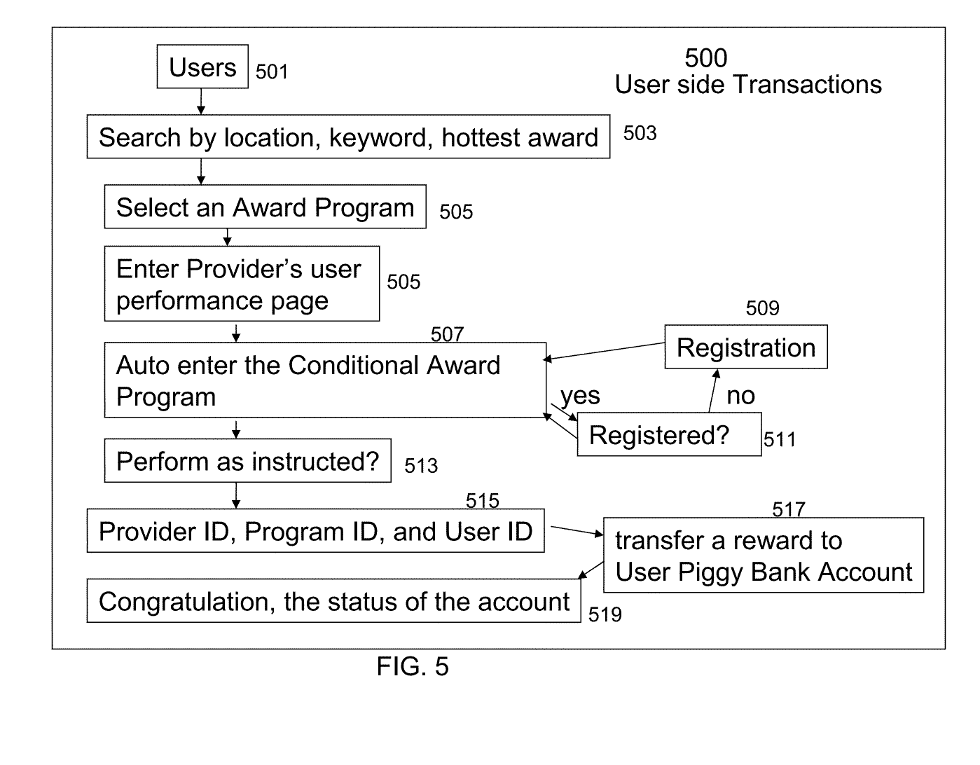

In reference to FIG. 5, an example of User side transaction chains 500 is shown. A User at step 501 can search with the Search Engine of the GOILAS system, either online through the Internet, or with a cell phone application of the system, for an Incentive Program, according to its interest. The search may be conducted with key words, locations, school names, etc. At step 503, the User then selects a program of interest from the displayed Program lists with links and enters the Program Provider's User Performance Page by clicking on the link at step 505. When the User submits the performance from the Provider's User Performance Page, it automatically enters into the Conditional Award Program of the GOILAS system linked with the User Performance Page at step 507, and its registration status is then checked and validated through the Registration component at steps 509 and 511. If the User is not registered, it is prompted for registration. If it is a registered user, then the User ID is retained and the system checks the performance submission to see if it is performed as instructed. The performance results are then converted into Award amount which, together with the Provider ID, Award Program ID and the User ID, are sent to Transaction Engine 107 to authorize a transfer and deposit of the Award amount into the User's Piggy Bank Account at step 515 and step 517. A message is then sent to the User about the completion of this transaction at step 519.

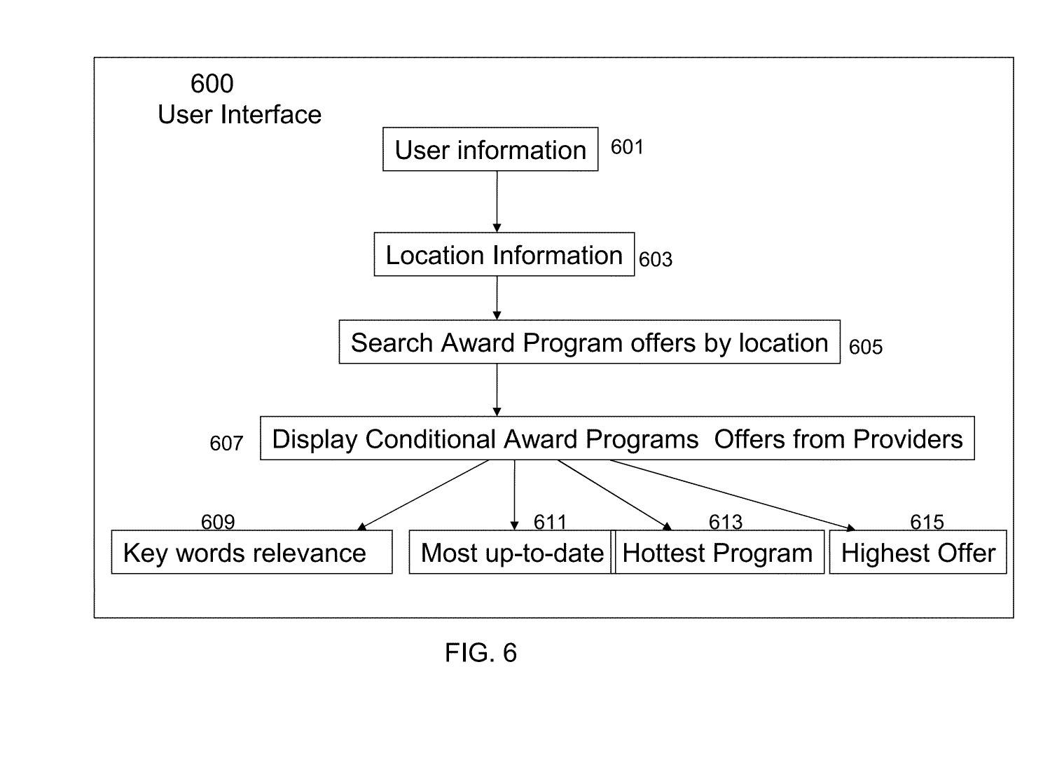

In reference to FIG. 6, an example set of inputs may be input by a user at its User Interface 600. For example, User or student information 601, location information 603 can be typed into the search box, and the system then searches the registered incentive programs at step 605. The search result of the relevant available Conditional Award Programs are then displayed at step 607. The display may also be arranged according to keywords relevance 609, most up-to-date 611, the hottest program (most popular) 613 or the highest offers 615 (highest incentives per performance, etc).

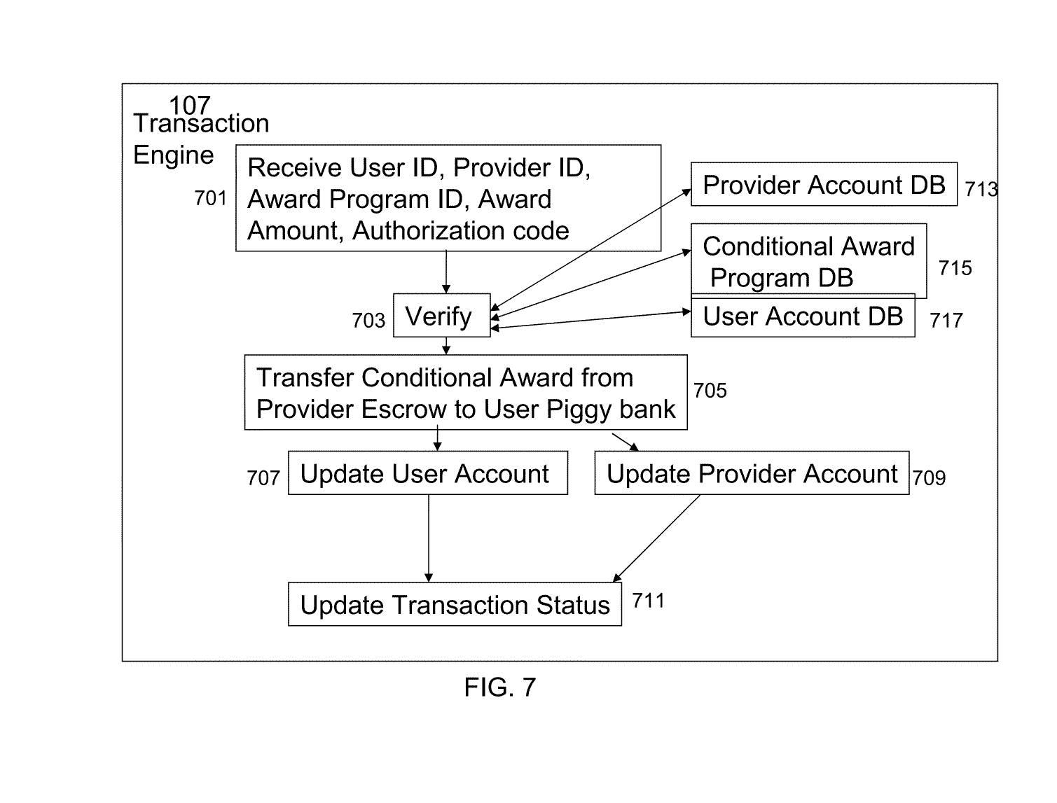

In reference to FIG. 7, an example functional flow chart of Transaction Engine 107 is shown. When the Transaction Engine 107 receives request and an authorization code from a Provider's User Performance Page, together with a User ID, Provider ID, Award Program ID and the award amount at step 701, it conducts a verification step at step 703 by accessing Provider Account Database 713, Conditional Award Database 715, and User Account Database 717. After positive validation, with the authorization code, the Transaction Engine 107 then directly access the Provider's Escrow Account to transfer the award amount to the User's Piggy Bank Account under the User ID at step 705. Then the User Account 707 and Provider Account 709 are updated and recorded with this transaction information. Transaction Status is tracked and updated accordingly at step 711.

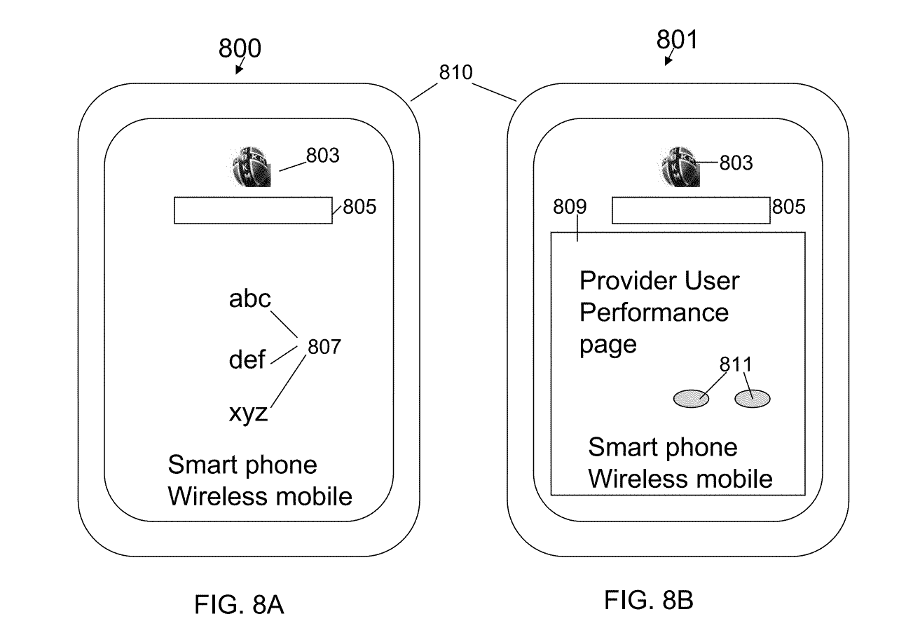

In reference to FIG. 8A, an example GOILAS interface 800 for a cell phone 810. On cell phone 810, the application Icon 803 is easily located on the top of the phone. With one click on Icon 803, the application is activated and a search input box 805 is displayed. With the input of keywords, or other information, such as location information, the search results 807 are displayed as hyperlinked listings. One click on one of those hyperlinked listing items, the User is directly shown with the Provider's User Performance Page 809 with submission buttons 811 as shown in FIG. 8B.

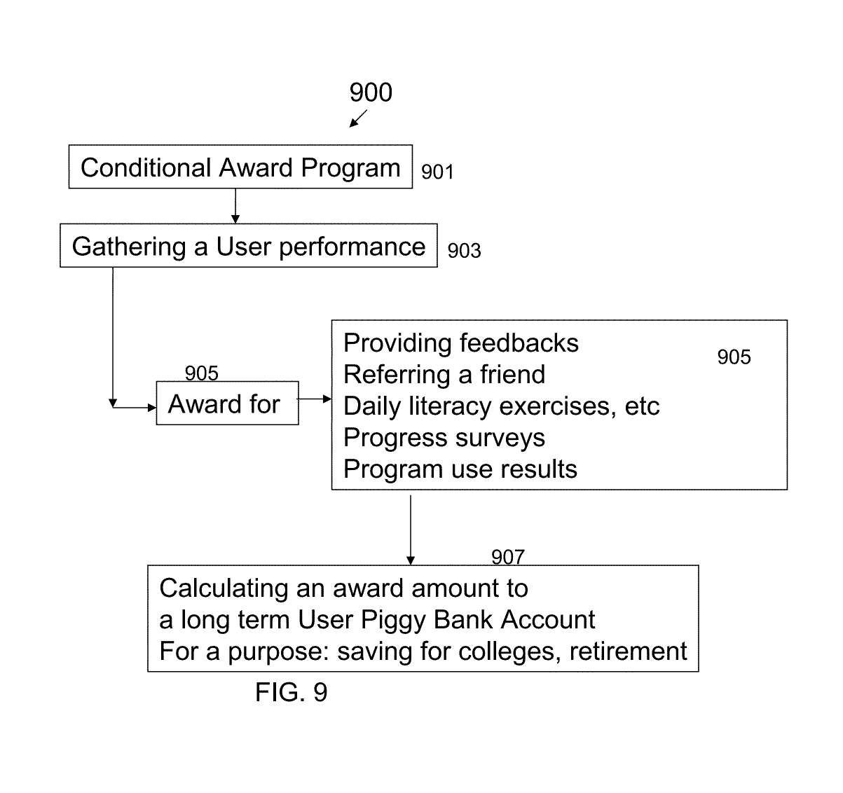

In reference to FIG. 9, an example functional flow chart 900 for a Conditional Award Program interface is shown. Once a User Performance is submitted, the Transaction Engine 107 enters the functions of the associated Conditional Award Program at step 901, and at step 903, gathers the results of a user's performance from the Provider's User Performance page, which may require a User, for example, to provide a feedback, answer a survey, conduct a set of literacy learning exercises, referring a friend, and retrieves the information from the Conditional Award Program Database about the pre-set incentives for these performances at step 905, then calculates and concludes an award for this performance at 907.

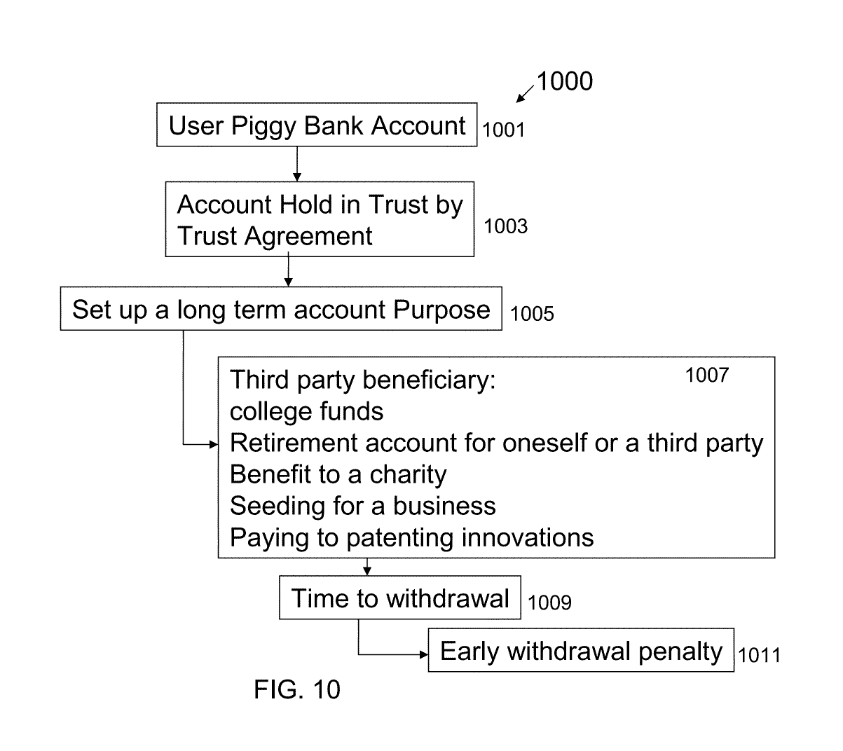

In reference to FIG. 10, an example flow chart 1000 for setting a User Piggy Bank Account is shown. At the User Piggy Bank set up page 1001, a User agrees to the terms on a Trust Agreement at step 1003, and then proceeds to select the long terms goals provided by the system at step 1005. The purported long term use choices may include paying for college educations, a retirement fund, a benefit fund for donating to a charity, an account for a third party beneficiary, providing seed money for starting a business, providing funds for patenting innovations. At step 1009, the length of time for the account to mature is specified, and with the selection of the length of time, a penalty for early withdrawal is also set at step 1011. The penalty may be severe, such as a 10-20% surcharge on the total amount of the account, to encourage a User to stick to its pre-set goal.

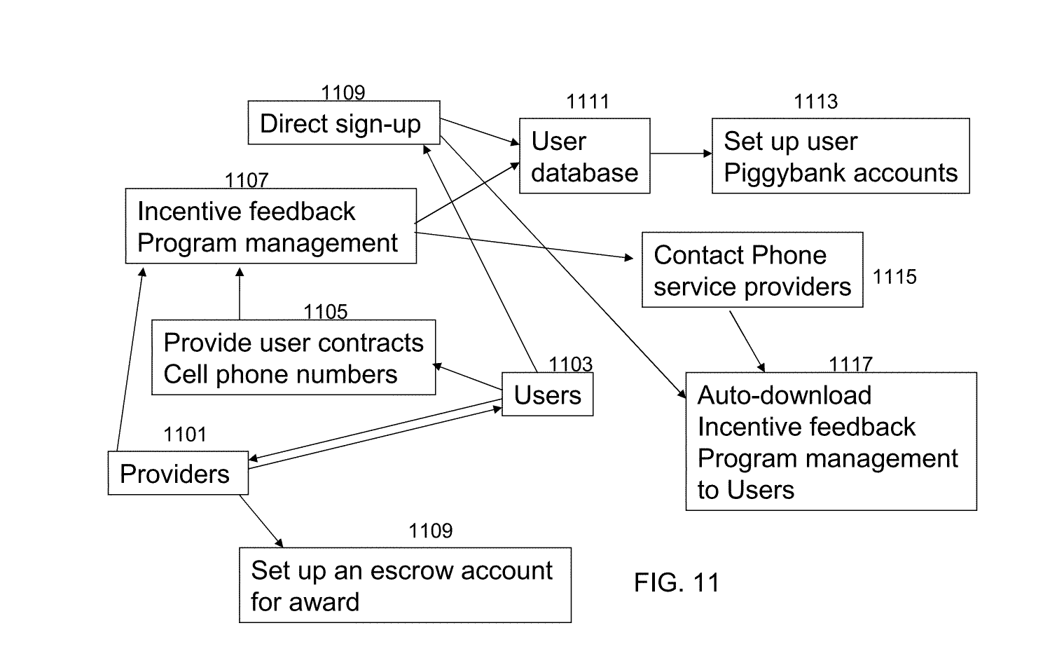

In reference to FIG. 11, an example set of interactions and automatic installation on user cell phones between the key actors and functional components are shown. A Provider 1101 can directly interact with a User 1103, and with Award/Incentive Feedback Program Management 1107 of the system to set up award programs. Provider 1101 has the sole authority to set up an award escrow account 1119 and associate it with the GOILAS system. A User 1103 can also direct interact with the system at 1109 for direct web-based registration or interact with a Provider by providing cell phone numbers and agreement with the Provider to sign up with a GOILAS system, through step 1105. Then the system proceeds to save the Provider and User information to databases at step 1111, and set up User Piggy Bank Accounts at step 1113. With the cell numbers and User agreements, the system can direct contact the User's cell phone service provider to automatically download the system application to the user's cell phone for use at 1117.

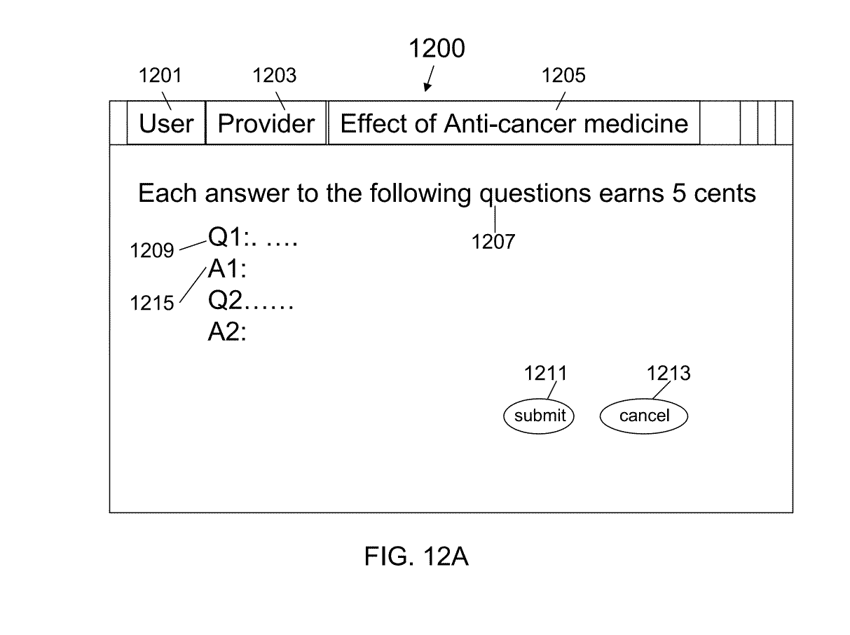

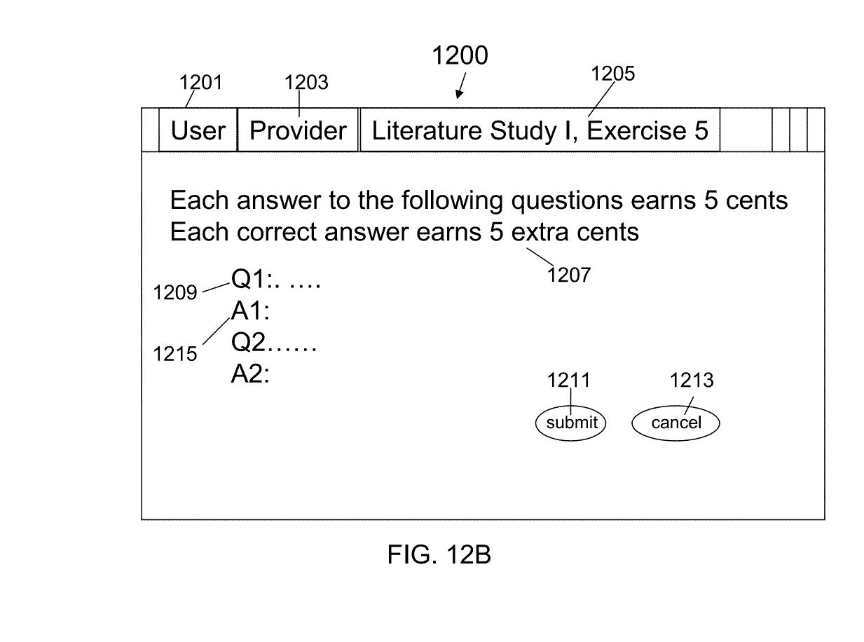

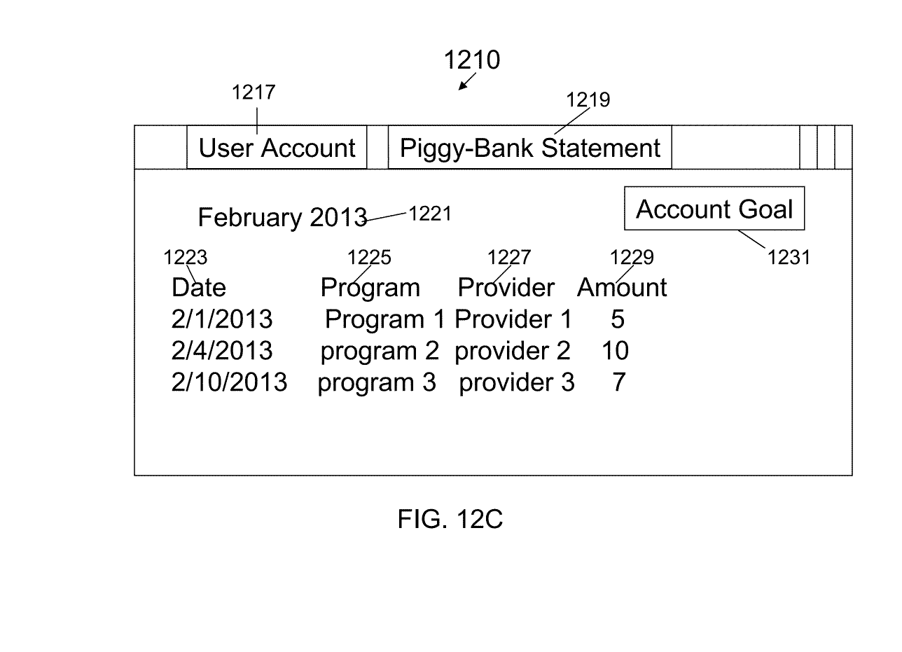

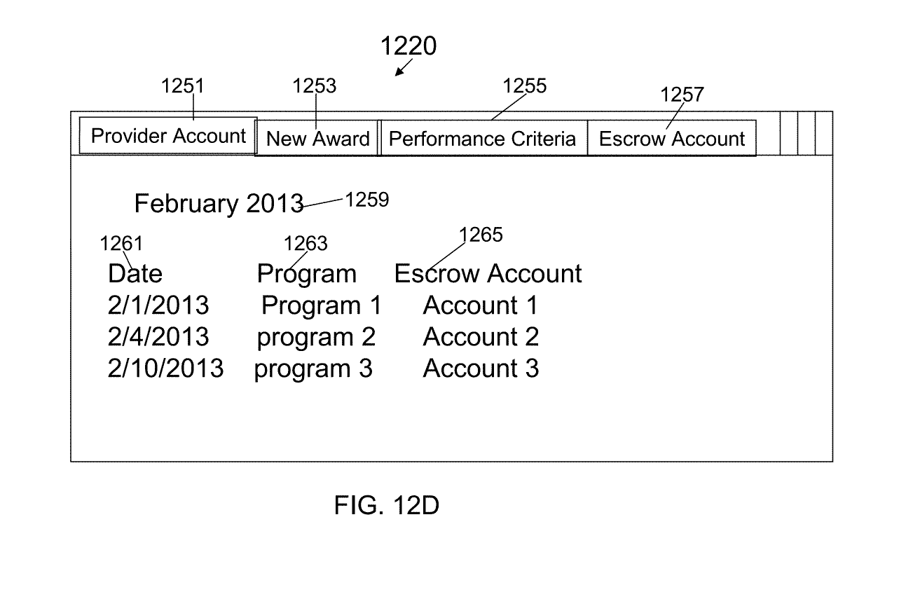

In reference to FIG. 12A, an example User Performance Page 1200 for survey of the effect of an anti-cancer medicine is shown. The Page includes information about User 1201, Provider 1203, Name of the Award Program 1205, information about the incentive offer 1207, the content of the survey questions 1209, space for input answers 1215, the submission button 1211 and a cancel button 1213. A Click on the submission button triggers the submission of the answers to the database of the provider, and the Transaction Engine of the system to calculate the awards.

Similarly, in reference to FIG. 12B, an example User Performance Page 1200 for Literature Study daily exercise is shown. And, in reference to FIG. 12C, an example User Piggy Bank Account Statement 1210 is shown. The statement may include the information of the name of user account 1217, the name of the Piggy Bank Statement 1219, the date period of the statement 1221, date of award transactions 1223, name of the programs 1225, provider names 1227, the amount deposited 1229, and the designated long term goal 1231.

In reference to FIG. 12D, a Provider's Account page 1220 may include a provider account name 1251, a bar button 1253 for creating new Award Programs, a bar button 1255 for specifying Performance criteria, and a bar button 1257 for providing an escrow account. The home page should include the date 1259, and a list of Programs that are already created with display of the date 1261, program name 1263, and the associated escrow account 1265.

The above description is intended to provide one preferred embodiment example of the system. It is contemplated and intended that such systems and concepts may be altered and modified by an ordinary person in the art to customize and provide other known and obvious web associated functionalities.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. The claims as filed are intended to be as comprehensive as possible, and NO subject matter is intentionally relinquished, dedicated, or abandoned.

What is claimed is:

1. A goal-oriented incentive learning and feedback electronic system for providing a conditional award to a user, comprising:
a plurality of computer processors configured with a plurality of modular computer functions, said plurality of modular computer functions comprising:
a provider-account database which stores a plurality of Third Party Providers with their respective associated information and Provider IDs;
a user-account database which stores a plurality of users with their respective associated information and User IDs;
a conditional-award-program database which stores a plurality of Conditional-Award programs configurable by a respective Third Party Provider, each Conditional-Award program having a Program ID and a Provider ID, wherein each of said Conditional-Award programs specifies a financial incentive in exchange for a user finishing a User Performance Program, and each of said Conditional-Award programs is linked with an escrow bank account provided by a respective Third Party Provider;
a user-piggy-bank-account database which stores a plurality of User-Piggy-Bank-Accounts, wherein each of said User-Piggy-Bank-Accounts is a trust account set up for a user, and each of said User-Piggy-Bank-Accounts is under a restriction of a long term goal having a contract-binding power;
a search engine component which provides a plurality of search functions for finding a Conditional-Award program; and
a transaction engine component which provides a plurality of management functions for said conditional-award-program database, said provider-account database, said user-account database, said user-piggy-bank-account database, wherein once a User Performance Program specified in a particular Conditional-Award program is satisfied by a particular user, an award calculated based on the particular Conditional-Award program is authorized and deposited to a Piggy Bank Account of said particular user.

2. The system of claim 1, wherein said long term goal is a goal that needs at least three year commitment or is a goal for a purpose selected from a group of choices consisting of supporting college education, retirement, starting a business, or patenting an innovation, and an early withdrawal triggers a penalty.

3. The system of claim 1, wherein said system has a user application automatically installable and executable on a wireless cellular phone.

4. The system of claim 1, wherein a user is enabled to set up multiple User-Piggy-Bank accounts, and each of the User-Piggy-Bank accounts is under restriction of a corresponding long term goal.

5. The system of claim 1, wherein the Third Party Provider is a parent to a user, a teacher to a user, a merchant or a survey entity.

6. The system of claim 1, wherein the User Performance Program is a literacy study, a school class practice, a feedback to a teacher, a survey for a medicine, a feedback to a merchant, or a survey by an organization.

7. The system of claim 1, wherein said escrow account is financed by a parent or a non-profit organization.

8. The system of claim 1, wherein said Conditional-Award program is reconfigurable.

9. The system of claim 1, further comprising a User Performance Program database wherein a Third Party Provider is enabled to store either a User Performance Program created on the system, or a link to an outside User Performance Program or an uploaded User Performance Program.

10. The system of claim 1, further comprising a Content Creating Engine for creating a User Performance Program.

11. A method for a goal-oriented incentive learning and feedbacks in relating to a user and a Third Party Provider, comprising:
providing a provider-account database which stores a plurality of Third Party Providers with their respective associated information and Provider IDs;
providing a user-account database which stores a plurality of users with their respective associated information and User IDs;
providing a conditional-award-program database which stores a plurality of Conditional-Award programs configurable by a respective Third Party Provider, each Conditional-Award program having a Program ID and a Provider ID, wherein each of said Conditional-Award programs specifies a financial incentive in exchange for a user finishing a User Performance Program, and each of said Conditional-Award programs is linked with an escrow bank account provided by a respective Third Party Provider;
providing a user-piggy-bank-account database which stores a plurality of User-Piggy-Bank-Accounts, wherein each of said User-Piggy-Bank-Accounts is a trust account set up for a user, and each of said User-Piggy-Bank-Accounts is under a restriction of a long term goal having a contract-binding power;
providing a search engine component which provides a plurality of search functions for finding a Conditional-Award program; and
providing a transaction engine component which provides a plurality of management functions for said conditional-award-program database, said provider-account database, said user-account database, said user-piggy-bank-account database, wherein once a User Performance Program specified in a particular Conditional-Award-program is satisfied by a particular user, an award calculated based on the particular Conditional-Award program is authorized and deposited to a Piggy Bank Account of said particular user.

12. The method of claim 11, wherein said long term goal is a goal that needs at least three year commitment or is a goal for a purpose selected from a group of choices consisting of supporting college education, retirement, starting a business, or patenting an innovation, and an early withdrawal triggers a penalty.

13. The method of claim 11, wherein said system has a user application automatically installable and executable on a wireless cellular phone.

14. The method of claim 11, wherein a user is enabled to set up multiple User-Piggy-Bank accounts, and each of the User-Piggy-Bank accounts is under restriction of a corresponding long term goal.

15. The method of claim 11, wherein the Third Party Provider is a parent to a user, a teacher to a user, a merchant or a survey entity.

16. The method of claim 11, wherein the User Performance is a literacy study, a school class practice, a feedback to a teacher, a survey for a medicine, a feedback to a merchant, or a survey by an organization.

17. The method of claim 11, wherein said escrow account is financed by a parent or a non-profit organization.
